(19) United States
(12) Patent Application Publication
(10) Pub. No.: US 2011/0058043 A1
(43) Pub. Date: Mar. 10, 2011

(54) IMAGE OUTPUT APPARATUS AND CONTROL METHOD THEREOF

(75) Inventor: Seung-won CHOI, Seoul (KR)

(73) Assignee: SAMSUNG ELECTRONICS CO., LTD., Suwon-si (KR)

(21) Appl. No.: 12/784,561

(22) Filed: May 21, 2010

(30) Foreign Application Priority Data
Sep. 7, 2009 (KR) 2009-0084227

(51) Int. Cl. H04N 3/227

(52) U.S. Cl. 348/177; 348/E03.042

(57) ABSTRACT

An image output apparatus and a control method thereof are provided. The control method of the image output apparatus adjusts and outputs an image according to an input position of the image output apparatus. Therefore, when a single image is displayed using a plurality of image output apparatuses, the size or resolution of an output image is automatically adjusted based on the input number and position of image output apparatuses, and thus user's convenience is improved.

### CROSS-REFERENCE TO RELATED APPLICATIONS

This application claims priority under 35 U.S.C. §119 from Korean Patent Application No. 10-2009-0084227, filed on Sep. 7, 2009, in the Korean Intellectual Property Office, the disclosure of which is incorporated herein by reference in its entirety.

### BACKGROUND OF THE INVENTION

1. Field of the Invention

Apparatuses and methods consistent with the present disclosure relate to an image output apparatus, and more particularly, to an image output apparatus in which images output from each image output apparatus are automatically adjusted based on the relative positions of the image output apparatuses which are set by a user using a menu without adjusting every image output from each image output apparatus.

2. Description of the Related Art

An image is displayed more clearly and vividly when a plurality of projectors rather than a single projector are used.

In order to use a plurality of projectors to output an image, a user should adjust the size of each image output from each of projectors since an image is displayed on a different location according to a position of a projector. To do so, a user should adjust the size of an image from each projector one by one. The inconvenience is even greater with a portable projector whenever the portable projector is disposed in different environment since the size of an image should be adjusted.

### SUMMARY

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

Exemplary embodiments of the present invention provides an image output apparatus which receives an input of the number of image output apparatuses and the position of each image output apparatus, and automatically adjusts the size or resolution of an output image based on the input number and position when a single image is displayed using a plurality of image output apparatuses.

According to an exemplary aspect, there is provided a controlling method of an image output apparatus, including inputting a position of the image output apparatus; and adjusting an image according to the position of the image output apparatus and outputting the image.

The inputting may further include outputting a menu on which the position of the image output apparatus is input; and receiving an input of the position of the image output apparatus through the menu.

The position of the image output apparatus may be a position relative to more than one another image output apparatus.

If another image output apparatus is provided, the position of the image output apparatus may be one of an upper portion, a lower portion, a left portion, and a right portion of the other image output apparatus.

If two other image output apparatuses are provided, the position of the image output apparatus may be one of an upper portion, a middle portion, and a lower portion of the other image output apparatuses, or one of a left portion, a middle portion, and a right portion of the other image output apparatuses.

The controlling method may further include inputting the number of the image output apparatus and the other image output apparatuses.

The adjusting and outputting may adjust and output a size of an image according to the position and number of the other image output apparatuses.

According to another exemplary aspect, there is provided an image output apparatus, including a light source unit; an input unit which receives a position of the image output apparatus; an image output unit which adjusts and outputs an image; and a controlling unit which controls the image output unit to adjust and output an image according to the position of the image output apparatus.

The controlling unit may control the image output unit to output a menu on which the position of the image output apparatus is input.

The position of the image output apparatus may be a position relative to more than one another image output apparatus.

If another image output apparatus may be provided, the position of the image output apparatus may be one of an upper portion, a lower portion, a left portion, and a right portion of the other image output apparatus.

If two other image output apparatuses are provided, the position of the image output apparatus may be one of an upper portion, a middle portion, and a lower portion of the other image output apparatuses, or one of a left portion, a middle portion, and a right portion of the other image output apparatuses.

The input unit may receive an input of the number of the image output apparatus and the other image output apparatuses.

The controlling unit may control the image output unit to adjust and output an image according to the position and number of the image output apparatuses.

According to yet another exemplary aspect, there is provided a method for controlling a projection system having a first projector and at least one second projector, the method including at the first projector, receiving a relative position of the first projector to the second projector; at the second projector, receiving a relative position of the second projector to the first projector; adjusting an image of the first projector according to the relative position input to the first projector and outputting the image; and adjusting and outputting an image of the second projector according to the relative position input to the second projector.

According to yet another exemplary aspect, there is provided a projection system having a first projector and at least one second projector, wherein the first projector may include a first input unit which receives an input of a relative position of the first projector to the second projector; and a first controlling unit which causes an image of the first projector to be adjusted and output according to the relative position input through the first input unit, and the second projector include a second input unit which receives an input of a relative position of the second projector and the first projector; and a second controlling unit which causes an image of the first projector to be adjusted and output according to the relative position input through the second input unit.

### BRIEF DESCRIPTION OF THE DRAWINGS

The above and/or other aspects will be more apparent by describing certain exemplary embodiments with reference to the accompanying drawings, in which:

FIG. 1 is a view illustrating the case of using two image output apparatuses according to an exemplary embodiment;

FIGS. 2A and 2B are views provided to explain the case of changing resolution and projection position of an image output apparatus;

FIG. 3 is a view illustrating an overlapping image after resolution and projection position of an image output apparatus are changed;

FIG. 4 is a view illustrating a menu screen on which the number of image output apparatuses and position of each image output apparatus are input while the image output apparatuses are disposed as shown in FIG. 1;

FIG. 5 is a view illustrating the case in which two image output apparatuses are disposed right and left according to another exemplary embodiment;

FIGS. 6A and 6B are views provided to explain the case of changing resolution and projection position of an image output apparatus;

FIG. 7 is a view illustrating an overlapping image after resolution and projection position of an image output apparatus are changed;

FIG. 8 is a view illustrating a menu screen on which the number of image output apparatuses and position of each image output apparatus are input while the image output apparatuses are disposed as shown in FIG. 5;

FIG. 9 is a view illustrating the case of using three image output apparatuses according to yet another exemplary embodiment;

FIG. 10 is a block diagram illustrating an image output apparatus applicable to an exemplary embodiment; and

FIG. 11 is a flowchart provided to explain a controlling method of an image output apparatus according to another exemplary embodiment.

### DETAILED DESCRIPTION OF EXEMPLARY EMBODIMENTS

Certain exemplary embodiments will now be described in greater detail with reference to the accompanying drawings.

In the following description, the same drawing reference numerals are used for the same elements even in different drawings. The matters defined in the description, such as detailed construction and elements, are provided to assist in a comprehensive understanding of the invention. Thus, it is apparent that the present invention can be carried out without those specifically defined matters. Also, well-known functions or constructions are not described in detail since they would obscure the invention with unnecessary detail.

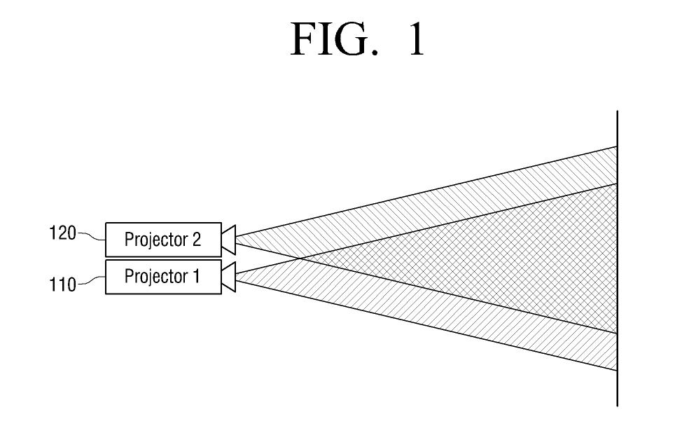

FIG. 1 is a view illustrating the case of using two image output apparatuses according to an exemplary embodiment. When a user desires to output a single image using two image output apparatuses 110 and 120, and the two image output apparatuses 110 and 120 are disposed vertically, a top area of an image output from the first image output apparatus 110 disposed on a lower portion overlaps with a bottom area of an image output from the second image output apparatus 120 disposed on an upper portion. The overlapping area is constant irrespective of a distance between the image output apparatuses and the position on which corresponding images are displayed.

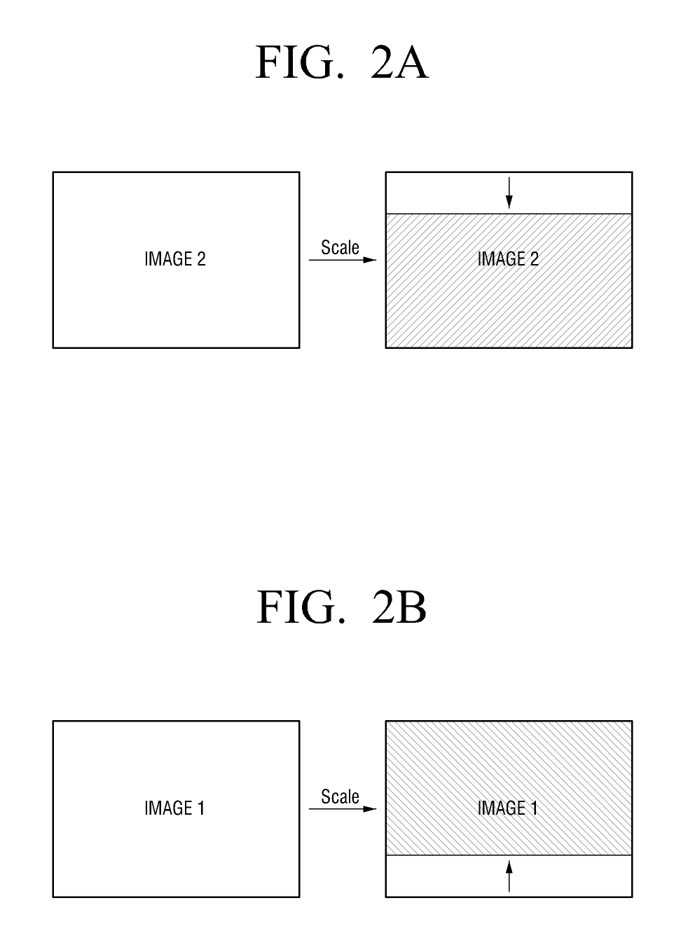

Each of the image output apparatus 110 and 120 needs to change resolution and projection position of an output image to project the same image on the overlapping area. FIG. 2A illustrates the case in which resolution and projection position of the image output from the second image output apparatus 120 disposed on an upper portion are changed. Since a bottom area of the image output from the second image output apparatus 120 disposed on an upper portion corresponds to an overlapping area, resolution and projection position of the image need to be changed.

FIG. 2B illustrates the case in which resolution and projection position of the image output from the first image output apparatus 110 disposed on a lower portion are changed. Since a top area of the image output from the first image output apparatus 110 disposed on a lower portion corresponds to an overlapping area, resolution and projection position of the image need to be changed.

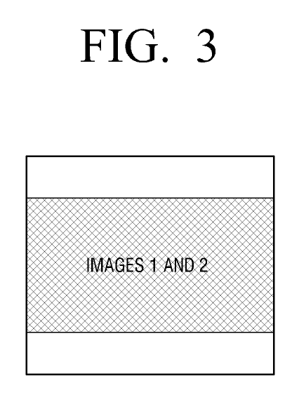

FIG. 3 is a view illustrating an overlapping image after resolution and projection position of each of the first and second image output apparatuses 110 and 120 are changed. The image shown in FIG. 3 is brighter than the images output from the first and second image output apparatuses 110 and 120.

Conventionally, when a single image is displayed using a plurality of image output apparatuses, a user should change resolution and projection position of every image output from each image output apparatus. However, this exemplary embodiment provides a menu screen to input the number of image output apparatuses and the position of each image output apparatus, and thus may change resolution and output position of images output from each image output apparatus according to the number of image output apparatuses and the position of each image output apparatus input on the menu screen.

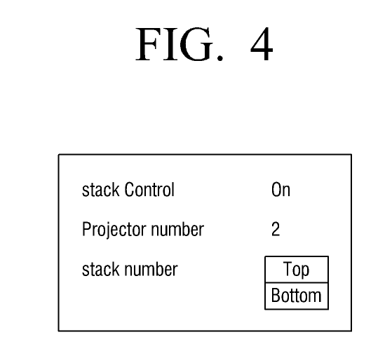

FIG. 4 is a view illustrating a menu screen on which the number of image output apparatuses and position of each image output apparatus are input while the image output apparatuses are disposed as shown in FIG. 1.

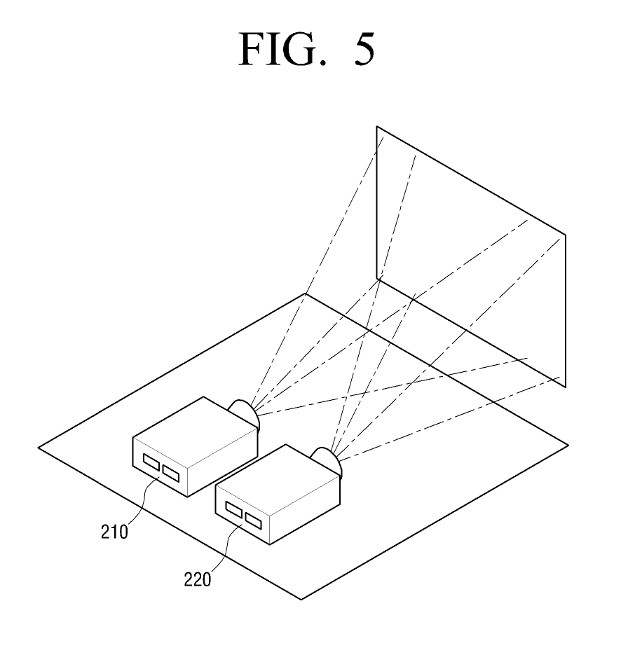

FIG. 5 is a view illustrating the case in which two image output apparatuses 210 and 220 are disposed right and left according to another exemplary embodiment. When a user desires to output a single image using two image output apparatuses 210 and 220 disposed horizontally, a right area of an image output from the first image output apparatus 210 disposed on a left portion overlaps with a left area of an image output from the second image output apparatus 220 disposed on a right portion.

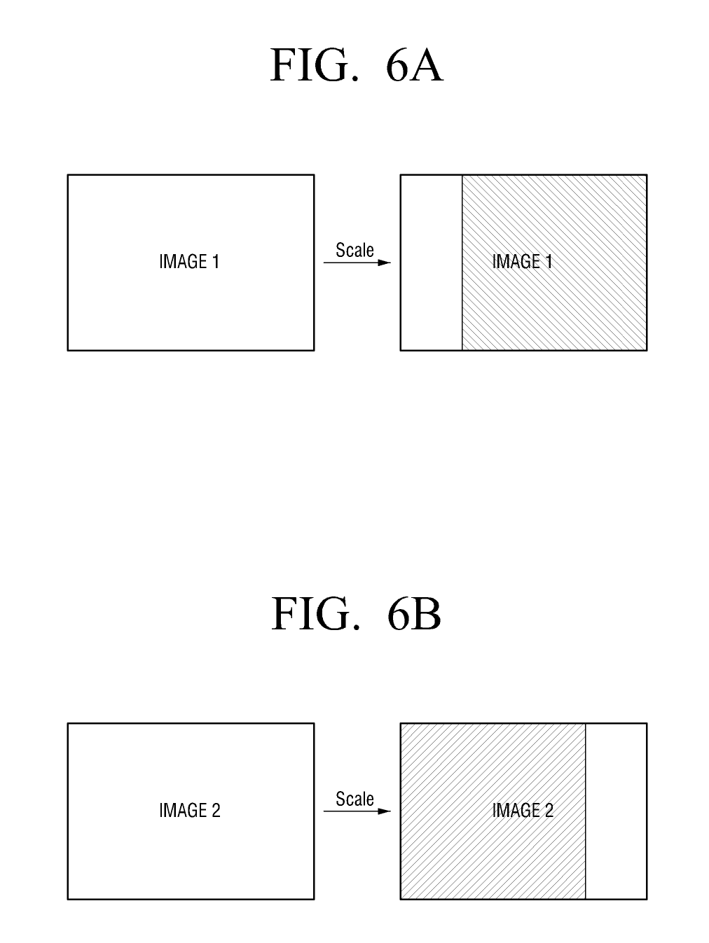

Each image output apparatus 210 and 220 needs to change resolution and projection position of an output image to project the same image on the overlapping area. FIG. 6A illustrates the case in which resolution and projection position of the image output from the first image output apparatus 210 disposed on a left portion are changed. Since a right area of the image output from the first image output apparatus 210 disposed on a left portion corresponds to an overlapping area, resolution and projection position of the image need to be changed.

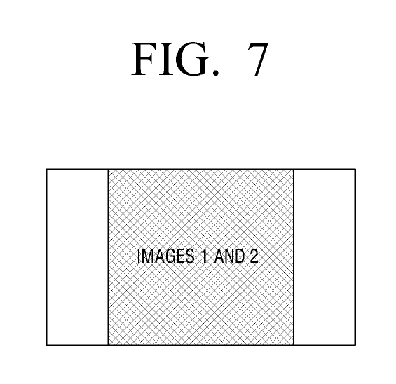

FIG. 6B illustrates the case in which resolution and projection position of the image output from the second image output apparatus 220 disposed on a right portion are changed. Since a left area of the image output from the second image output apparatus 220 disposed on a right portion corresponds to an overlapping area, resolution and projection position of the image need to be changed. FIG. 7 is a view illustrating an overlapping image after resolution and projection position of each of image output apparatuses 210 and 220 are changed.

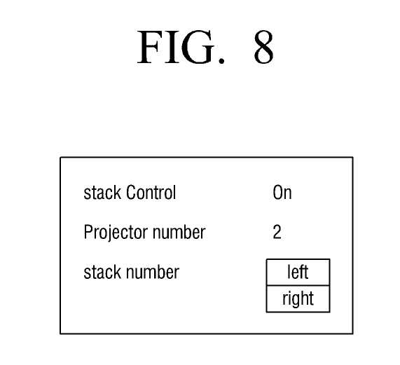

FIG. 8 is a view illustrating a menu screen on which the number of image output apparatuses and position of each image output apparatus are input while the image output apparatuses are disposed as shown in FIG. 5.

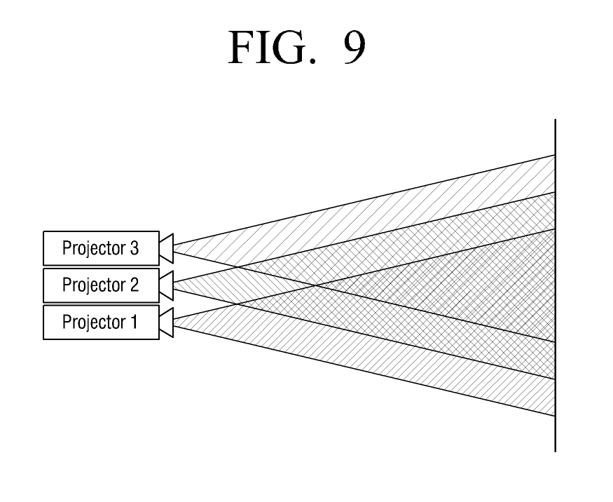

FIG. 9 is a view illustrating the case of using three image output apparatuses according to yet another exemplary embodiment. The technical aspects of the present invention may also be applied when four or more image output apparatuses are used.

In addition, three image output apparatuses may be disposed vertically or horizontally.

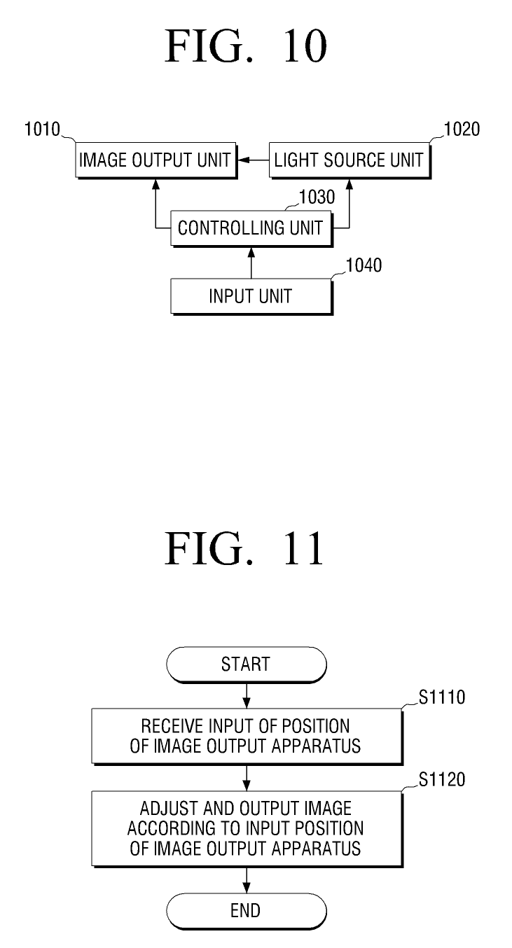

FIG. 10 is a block diagram illustrating an image output apparatus applicable to an exemplary embodiment. Referring to FIG. 10, the image output apparatus comprises an image output unit 1010, a light source unit 1020, a controlling unit 1030, and an input unit 1040.

The image output unit 1010 generates an image using light emitted from the light source unit 1020, and outputs the generated image.

The input unit 1040 is a user interface which receives an input of the position of the image output apparatus.

The controlling unit 1030 controls the image output unit 1010 to adjust and output an image according to the input position of the image output apparatus, which will be explained in detail with reference to FIG. 11.

FIG. 11 is a flowchart provided to explain a controlling method of an image output apparatus according to another exemplary embodiment of the present invention.

Referring to FIG. 11, the controlling unit 1030 receives an input of the position of the image output apparatus (S1110). The controlling unit 1030 adjusts and outputs an image according to the position of the image output apparatus which is input in operation S1110 (S1120).

The position of the image output apparatus may be input through a menu screen or the input unit 1040 in operation S1110.

The position of the image output apparatus which is input in operation S1110 represents a position relative to another image output apparatus.

Specifically, if another image output apparatus is provided, the position of the image output apparatus may be one of an upper portion, a lower portion, a left portion, and a right portion of the another image output apparatus.

Alternatively, if two other image output apparatuses are provided, the position of the image output apparatus may be one of an upper portion, a middle portion, and a lower portion of the other image output apparatuses, or one of a left portion, a middle portion, and a right portion of the other image output apparatuses.

The controlling unit 1030 may further receive an input of the number of image output apparatuses including the image output apparatuses, and may adjust and output the size of an image according to the input position and number of the image output apparatuses.

As described above, according to exemplary embodiments, when a single image is displayed using a plurality of image output apparatuses, the size or resolution of the output image is automatically adjusted based on the input number and position of image output apparatuses. Therefore, the present invention provides a user with convenience.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A controlling method of an image output apparatus, comprising:
inputting a position of the image output apparatus; and
adjusting an image according to the position of the image output apparatus and outputting the image.

2. The controlling method as claimed in claim 1, wherein the inputting comprises:
outputting a menu on which the position of the image output apparatus is input; and
receiving an input of the position of the image output apparatus through the menu.

3. The controlling method as claimed in claim 2, wherein the position of the image output apparatus is a position relative to an other image output apparatus.

4. The controlling method as claimed in claim 3, wherein the position of the image output apparatus is one of an upper portion, a lower portion, a left portion, and a right portion of the other image output apparatus.

5. The controlling method as claimed in claim 3, wherein a second other image output apparatuses is provided, and the position of the image output apparatus is one of an upper portion, a middle portion, and a lower portion of the other image output apparatuses, or one of a left portion, a middle portion, and a right portion of the other image output apparatuses.

6. The controlling method as claimed in claim 1, further comprising:
inputting a number corresponding to a number of image output apparatuses.

7. The controlling method as claimed in claim 6, wherein the adjusting and outputting adjusts and outputs a size of an image according to the position and the number corresponding to a number of other image output apparatuses.

8. An image output apparatus, comprising:
a light source unit;
an input unit which receives a position of the image output apparatus;
an image output unit which adjusts and outputs an image; and
a controlling unit which controls the image output unit to adjust and output an image according to the position of the image output apparatus.

9. The image output apparatus as claimed in claim 8, wherein the controlling unit controls the image output unit to output a menu on which the position of the image output apparatus is input.

10. The image output apparatus as claimed in claim 9, wherein the position of the image output apparatus is a position relative to an other image output apparatus.

11. The image output apparatus as claimed in claim 10, wherein if one other image output apparatus is provided, the position of the image output apparatus is one of an upper portion, a lower portion, a left portion, and a right portion of the other image output apparatus.

12. The image output apparatus as claimed in claim 10, wherein a second other image output apparatuses is provided, and the position of the image output apparatus is one of an upper portion, a middle portion, and a lower portion of the other image output apparatuses, or one of a left portion, a middle portion, and a right portion of the other image output apparatuses.

13. The image output apparatus as claimed in claim 8, wherein the input unit receives an input of a number corresponding to a number of image output apparatuses.

14. The image output apparatus as claimed in claim 13, wherein the controlling unit controls the image output unit to adjust and output an image according to the position and the number corresponding to a number of image output apparatuses.

15. A method for controlling a projection system having a first projector and at least one second projector, the method comprising:
at the first projector, receiving a relative position of the first projector to the second projector;
at the second projector, receiving a relative position of the second projector to the first projector;
adjusting an image of the first projector according to the relative position input to the first projector and outputting the image of the first projector; and
adjusting and outputting an image of the second projector according to the relative position input to the second projector.

16. A projection system having a first projector and at least one second projector, wherein
the first projector comprises:
a first input unit which receives an input of a relative position of the first projector to the second projector; and
a first controlling unit which causes an image of the first projector to be adjusted and output according to the relative position input through the first input unit, and
the second projector comprises:
a second input unit which receives an input of a relative position of the second projector to the first projector; and
a second controlling unit which causes an image of the first projector to be adjusted and output according to the relative position input through the second input unit.

17. The controlling method as claimed in claim 1, wherein the position of the image output apparatus is a position relative to at least two other image output apparatuses.

18. The controlling method as claimed in claim 1,
wherein the adjusting and outputting adjusts a resolution and a projection position of the image output by the image output apparatus based on the relative position and outputs the image.

19. The method as claimed in claim 15, wherein the adjusting and outputting of the first projector adjusts a resolution and a projection position of the image of the first projector according to the relative position input to the first projector and outputs the image of the first projector; and
wherein the adjusting and outputting of the second projector adjusts a resolution and a projection position of the image of the second projector according to the relative position input to the second projector and outputs the image of the second projector.
